(19) United States
(12) Patent Application Publication
(10) Pub. No.: US 2026/0044764 A1
(43) Pub. Date: Feb. 12, 2026

(54) QUANTUM VERIFICATION CIRCUIT AND METHOD FOR VERIFYING QUANTUM GATE USING THE SAME

(71) Applicant: KOREA ADVANCED INSTITUTE OF SCIENCE AND TECHNOLOGY, Daejeon (KR)

(72) Inventors: Joonwoo BAE, Daejeon (KR); Jiheon SEONG, Daejeon (KR)

(21) Appl. No.: 19/084,448

(22) Filed: Mar. 19, 2025

(30) Foreign Application Priority Data
Aug. 7, 2024 (KR) 10-2024-0105592

(51) Int. Cl. G06N 10/20; G06N 10/70

(52) U.S. Cl. CPC G06N 10/20; G06N 10/70

(57) ABSTRACT

A quantum verification circuit includes a first verification circuit to which a plurality of qubits are input, and configured to output to a verification target gate by performing an operation based on the plurality of qubits, a second verification circuit to which the plurality of qubits in entangled state are input from the verification target gate, and configured to perform an operation based on plurality of qubits in entangled state and a quantum measurement configured to receive an output of the second verification circuit, and configured to determine whether the verification target gate is normally implemented by determining the entangled state of the plurality of qubits.

### CROSS-REFERENCE TO RELATED APPLICATION(S)

This application claims priority under 35 U.S.C. § 119 to Korean Patent Application No. 10-2024-0105592, filed on Aug. 7, 2024, which is hereby incorporated by reference for all purposes as if fully set forth herein.

### BACKGROUND

### 1. Field

Embodiments relate to a quantum verification circuit and a method for verifying quantum gate using the same. More particularly, the embodiments relate to the quantum verification circuit for implementing a hardware of a quantum computer and the method for verifying quantum gate using the same.

### 2. Description of the Related Art

It is known that some algorithms that increase in computational complexity by exponentiation in a traditional computer can be executed in polynomial time in a quantum computer, based on the principle of quantum entanglement and quantum superposition. Therefore, there have been developments in utilizing quantum computing to elucidate physical phenomena and chemical principles that were previously unsolvable. However, the quantum computer has serious characteristic errors in quantum measurements due to difficulty of implementation. Therefore, research on computers that allow noise and quantum error correction technology are developing.

Quantum algorithms are created at a circuit level for quantum information processing, and a quantum circuit can be created in various versions for experiments. In a digital logic circuit, complex and diverse logic gates can be used as NAND gates or NOR gates. Similarly, research is being conducted to find a universal gate set that proves whether a circuit can be replaced with another gate for gate-based algorithm design in quantum circuits. The universal gate set includes a Hadamard gate, a T-gate, and a CNOT (Controlled NOT, CX Gate) gate, and the like.

### SUMMARY

Embodiments provide a quantum verification circuit for effectively verifying an implementation of a CNOT gate.

Embodiments provide a method for verifying a quantum gate using the quantum verification circuit.

A quantum verification circuit according to an embodiment includes a first verification circuit, a second verification circuit, and a quantum measurement. The first verification circuit receive a plurality of qubits, perform a first operation based on the plurality of qubits and output a result of the first operation to a verification target gate. The second verification circuit receive the plurality of qubits in an entangled state from the verification target gate, and perform a second operation based on the plurality of qubits in the entangled state. The quantum measurement receive an output of the second verification circuit, and determine whether the verification target gate is normally implemented by determining the entangled state of the plurality of qubits.

In an embodiment, the verification target gate may be CNOT gate.

In an embodiment, the first verification circuit may include at least one selected from a group consisting of a Pauli-X-gate, a CNOT gate, and a Hadamard gate, and the second verification circuit may include the Hadamard gate.

In an embodiment, the first verification circuit may further include a controlled Hadamard gate defined as a gate configured to perform a matrix operation according to an [equation 1] below.

$$( \begin{matrix}1 & 0 & 0 & 0 \\ 0 & 1 & 0 & 0 \\ 0 & 0 & \frac{1}{\sqrt{2}} & \frac{1}{\sqrt{2}} \\ 0 & 0 & \frac{1}{\sqrt{2}} & - \frac{1}{\sqrt{2}}\end{matrix} ) \qquad [ equation 1 ]$$

In an embodiment, a first qubit, a second qubit, a third qubit, and a fourth qubit may be input to the first verification circuit.

In an embodiment, the first verification circuit may generate an output according to an [equation 2] below including a first vector, a second vector, and a third vector based on the first qubit, the second qubit, the third qubit, and the fourth qubit.

$${{{{{{\vert = \frac{1}{2} \vert {Φ}_{-} 〉}_{1 , 2} \vert {E}_{10} 〉}_{{1}^{′} , {2}^{′}} + \frac{1}{2} \vert {Ψ}_{+} 〉}_{1 , 2} \vert {E}_{01} 〉}_{{1}^{′} , {2}^{′}} + \sqrt{\frac{1}{2}} \vert {Ψ}_{-} 〉}_{1 , 2} \vert {E}_{11} 〉}_{{1}^{′} , {2}^{′}} \qquad [ equation 2 ]$$

Where, | [symbol] [symbol] is the output of the first verification circuit, |E₁₀ [symbol] _{1′2′} is the first vector, |E₀₁ [symbol] _{1′2′} is the second vector, |E₁₁ [symbol] _{1′2′} is the third vector, 1, 2, 1′, and 2′ are the first qubit, the second qubit, the third qubit, and the fourth qubit respectively, and |ϕ₋ [symbol] _{1,2,}|Ψ₊ [symbol] _{1,2}, and |Ψ₋ [symbol] _{1,2} are defined by an [equation 3] below.

$${{{{{\vert {Φ}_{-} 〉}_{1 , 2} = \sqrt{\frac{1}{2}} ( \vert 0 〉}_{1} \vert 0 〉}_{2} - \vert 1 〉}_{1} \vert 1 〉}_{2} ) \qquad [ equation 3 ]$$

$${{{{{\vert {Ψ}_{+} 〉}_{1 , 2} = \sqrt{\frac{1}{2}} ( \vert 0 〉}_{1} \vert 0 〉}_{2} - \vert 1 〉}_{1} \vert 1 〉}_{2} )$$

$${{{{{\vert {Ψ}_{-} 〉}_{1 , 2} = \sqrt{\frac{1}{2}} ( \vert 0 〉}_{1} \vert 1 〉}_{2} - \vert 1 〉}_{1} \vert 0 〉}_{2} )$$

In an embodiment, the first vector, the second vector, and the third vectors may be orthogonal to each other.

In an embodiment, when each of the first vector, the second vector, the third vector, and the fourth vector is input as |0>, the quantum measurement may determine whether the verification target gate is normally implemented by measuring a verification probability defined as a probability that values of qubits output from the second verification circuit based on the first qubit and the second qubit are all zero.

In an embodiment, when a value of the verification probability is less than about 0.125, the quantum measurement may determine that a normal implementation of the verification target gate is successful.

In an embodiment, when a value of the verification probability is equal to or greater than about 0.125 and to or less than about 0.375, the quantum measurement may determine that a normal implementation of the verification target gate fails.

In an embodiment, the second verification circuit may include at least one selected from a group consisting of a Pauli-X-gate, a CNOT gate, and a Hadamard gate.

In an embodiment, the first verification circuit may include the Hadamard gate. The second verification circuit further may include a controlled Hadamard gate.

In an embodiment, when each of a first qubit, a second qubit, a third qubit, and a fourth qubit is input as |0>, the quantum measurement may determine whether the verification target gate is normally implemented by measuring a sum of measurement probabilities defined as a verification probability that a value output from the second verification circuit for each of the first qubit and the second qubit has a specific value.

In an embodiment, the specific value for each of the first qubit and the second qubit may be zero, and the quantum measurement may operate the sum of the measurement probabilities according to an [equation 4] below.

$${P}_{00} = {P}_{0000} + {P}_{0001} + {P}_{0010} + {P}_{0011} \qquad [ equation 4 ]$$

Where, P₀₀ is the verification probability, P_{abcd} is each of the measurement probabilities, and each of a, b, c, and d is a value output to the quantum measurement for the first qubit, the second qubit, the third qubit, and the fourth qubit.

In an embodiment, when a value of the verification probability is less than about 0.125, the quantum measurement may determine that a normal implementation of the verification target gate is successful.

In an embodiment, when each of a first qubit, a second qubit, a third qubit, and a fourth qubit is input as |0>, the quantum measurement may determine whether the verification target gate is normally implemented by measuring a verification probability defined as a probability that all values output from the second verification circuit for each of the first qubit, the second qubit, the third qubit, and the fourth qubit are zero.

A method for verifying a quantum gate according to an embodiment includes generating qubits in a preliminary state for verification based on at least two or more qubits, generating an entangled state by inputting the qubits in the preliminary state to a verification target gate and determining whether the verification target gate is normally implemented by measuring the entangled state.

In an embodiment, in the generating the qubits in the preliminary state, the qubits in the preliminary state may be generated based on a first qubit and a second qubit, each of the first qubit, the second qubit, a third qubit, and a fourth qubit may be input as |0>, and in the determining whether the verification target gate is normally implemented, whether the targe verification gate is normally implemented may be determined by measuring a sum of measurement probabilities defined as a probability that a value output from the second verification circuit for each of the first qubit and the second qubit has a specific value.

In an embodiment, in the determining whether the verification target gate is normally implemented, the specific value output based on the first qubit and the second qubit may be zero, the verification probability may be operated according to an [equation 5] below, and when the verification probability is less than about 0.125, a success of normal implementation of the verification target gate may be determined.

$${P}_{00} = {P}_{0000} + {P}_{0001} + {P}_{0010} + {P}_{0011} \qquad [ equation 5 ]$$

Where, P₀₀ is the verification probability, P_{abcd} is each of the measurement probabilities, and each of a, b, c, and d is a value output for the first qubit, the second qubit, the third qubit, and the fourth qubit.

In an embodiment, in the generating the qubits in the preliminary state, the qubits in the preliminary state may be generated based on a first qubit, a second qubit, a third qubit, and a fourth qubit. Each of the first qubit, the second qubit, the third qubit, and the fourth qubit may be input as |0>. In the determining whether the verification target gate is normally implemented, when a probability that values of qubits output based on the first qubit, the second qubit, the third qubit, and the fourth qubit are all zero is less than about 0.125, a success of normal implementation of the verification target gate may be determined. And in the determining whether the verification target gate is normally implemented, when the probability that values of qubits output based on the first qubit, the second qubit, the third qubit, and the fourth qubit are all zero is equal to or greater than about 0.125 and equal to or less than about 0.375, a failure of the normal implementation of the verification target gate may be determined.

In a quantum verification circuit and a method for verifying quantum gate using the same according to embodiments of the present inventive concept, as whether the verification target gate is normally implemented is determined by disposing a verification target gate between a first verification circuit and a second verification circuit, and measuring states of qubits that have passed through the first verification circuit, the verification target gate, and the second verification circuit, whether a quantum gate, which is the verification target gate, succeeds or fails to implement an entangled state is easily determined. Accordingly, verification accuracy and efficiency of the quantum gate (e.g., a CNOT gate) that implements the entangled state may be improved.

Accordingly, the quantum gate may be applied to a quantum circuit and a device, so a performance of the quantum circuit and the device using the quantum gate may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an operation of a quantum verification circuit according to an embodiment of the present inventive concept.

FIG. 2 is a view illustrating an example of the quantum verification circuit of FIG. 1.

FIG. 3 is a view illustrating a first verification circuit of FIG. 2.

FIG. 4 is a view illustrating a second verification circuit of FIG. 2.

FIGS. 5, 6, and 7 are views illustrating a method for verifying a quantum gate using the quantum verification circuit of FIG. 2.

FIG. 8 is a view illustrating another example of the quantum verification circuit of FIG. 1.

FIG. 9 is a view illustrating a first verification circuit of FIG. 8.

FIG. 10 is a view illustrating a second verification circuit of FIG. 8.

FIGS. 11, 12, and 13 are views illustrating a method for verifying a quantum gate using the quantum verification circuit of FIG. 8.

FIGS. 14, 15, and 16 are views explaining for an effect of the quantum verification circuit of FIG. 1.

### DETAILED DESCRIPTION OF THE EMBODIMENTS

The present inventive concept now will be described more fully hereinafter with reference to the accompanying drawings, in which embodiments of the present inventive concept are shown. The present inventive concept may, however, be embodied in many different forms and should not be construed as limited to the embodiments set forth herein.

Rather, these embodiments are provided so that this inventive concept will be thorough and complete, and will fully convey the scope of the present inventive concept to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the inventive concept and does not pose a limitation on the scope of the inventive concept unless otherwise claimed. No language in the specification should be construed as indicating any non-claimed element as essential to the practice of the inventive concept as used herein.

Hereinafter, a quantum verification circuit and a method for verifying quantum gate using the same in accordance with embodiments will be described in more detail with reference to the accompanying drawings. The same reference numerals are used for the same components in the drawings, and redundant descriptions of the same components will be omitted.

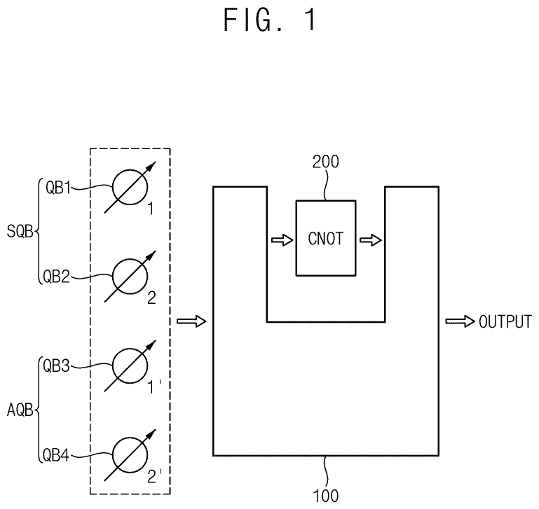

FIG. 1 is a block diagram illustrating an operation of a quantum verification circuit according to an embodiment of the present inventive concept.

Referring to FIG. 1, at least one qubit may be input to a quantum verification circuit 100 according to an embodiment of the present inventive concept. For example, system qubit SQB and auxiliary qubit AQB may be input to the quantum verification circuit 100. The system qubit SQB may include a first qubit QB1 and a second qubit QB2. The auxiliary qubit AQB may include a third qubit QB3 and a fourth qubit QB4. The first, second, third, and fourth qubits QB1, QB2, QB3, and QB4 may have values which are different from each other or are equal to each other. A number of the qubits input to the quantum verification circuit 100 is illustrated as four, however the number of the qubits input to the quantum verification circuit 100 may not be limited to thereto, and various numbers of qubits may be input to the quantum verification circuit 100.

The quantum verification circuit 100 may be connected to the verification target gate 200. For example, the quantum verification circuit 100 may connected to each of one terminal of the verification target gate 200 and another terminal opposite to the one terminal of verification target gate 200. Accordingly, the quantum verification circuit 100 may adjust, measure, or control states of qubits input to the verification target gate 200 and qubits output from the verification target gate 200. The first, second, third, and fourth qubits QB1, QB2, QB3, and QB4 may be in a superposition state or an entangled state with each other as the first, second, third, and fourth qubits QB1, QB2, QB3, and QB4 pass through the quantum verification circuit 100 and the verification target gate 200. The quantum verification circuit 100 may perform an operation based on the first, second, third, and fourth qubits QB1, QB2, QB3, and QB4. The verification target gate 200 may perform an operation based on the first and second qubits QB1 and QB2. However, a number of qubits on which the quantum verification circuit 100 and the verification target gate 200 according to embodiments of the present inventive concept perform operations may not be limited thereto, and each of the quantum verification circuit 100 and the verification target gate 200 may perform operations on a variety of numbers of qubits.

In an embodiment, the verification target gate 200 may be a CNOT (controlled NOT) gate. Qubits passing through the CNOT gate may be converted into a quantum entangled state. The CNOT gate may include a target portion and a control portion. A control qubit for control may be input to the control portion, and a target qubit corresponding to the target may be input to the target portion. The CNOT gate may perform an operation based on a Pauli-X-gate on the target qubit according to a state of the control qubit, or may pass the target qubit. Specifically, the CNOT gate may pass the target qubit input to the CNOT gate when the control qubit input to the CNOT gate is |0>. In addition, the CNOT gate may perform an operation by a Pauli-X-gate on the target qubit input to the CNOT gate when the control qubit input to the CNOT gate is |1>.

An output of the verification target gate 200 may be input to the quantum verification circuit 100. The quantum verification circuit 100 may perform an operation based on the output of the verification target gate 200. After performing the operation, the quantum verification circuit 100 may output qubits based on the first, second, third, and fourth qubits QB1, QB2, and QB3, QB4. In addition, the quantum verification circuit 100 may generate a probability distribution of values of the output qubits. The quantum verification circuit 100 may determine whether the verification target gate 200 is normally implemented using a value of the probability distribution.

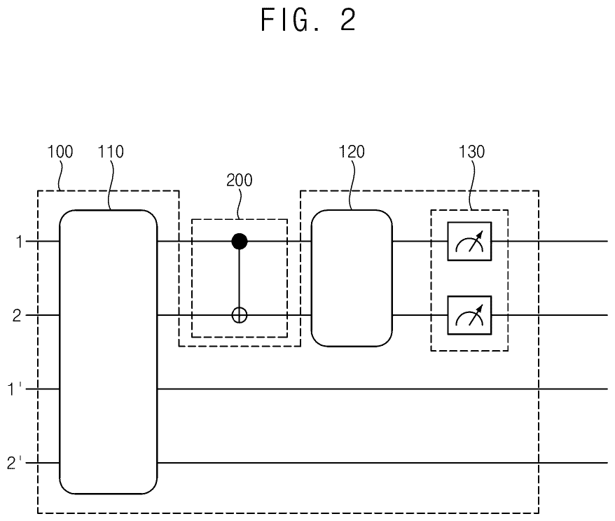

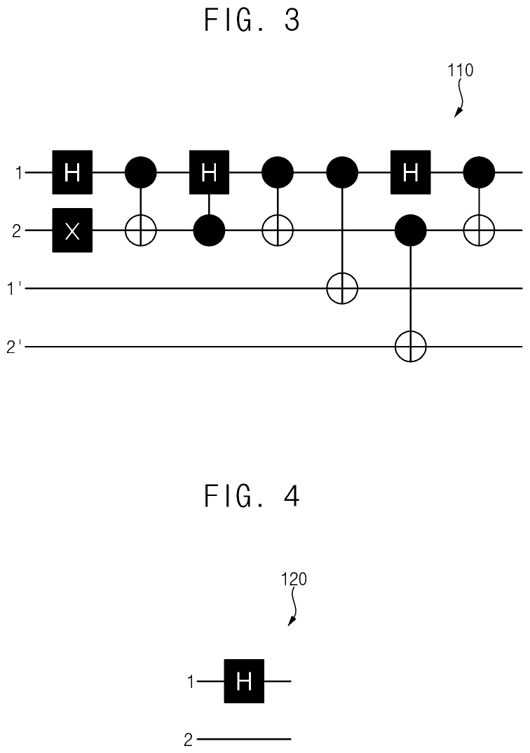

FIG. 2 is a view illustrating an example of the quantum verification circuit of FIG. 1. FIG. 3 is a view illustrating a first verification circuit of FIG. 2. FIG. 4 is a view illustrating a second verification circuit of FIG. 2.

Referring to FIGS. 1, 2, 3, and 4, the quantum verification circuit 100 may include a first verification circuit 110, a second verification circuit 120, and a quantum measurement 130. The first verification circuit 110 may be connected to the one side of the verification target gate 200. The second verification circuit 120 may be connected to the another side opposite to the one side of the verification target gate 200.

The system qubit SQB and the auxiliary qubit AQB may be input to the first verification circuit 110. For example, the first verification circuit 110 may receive the first, second, third, and fourth qubits QB1, QB2, QB3, and QB4 and perform an operation based on the first, second, third, and fourth qubits QB1, QB2, QB3, and QB4 to generate qubits in a preliminary state for verification. The qubits in the preliminary state may be input to the verification target gate 200. Qubits based on the system qubit SQB may be input to the verification target gate 200. Qubits based on the system qubit SQB may be input to the second verification circuit 120. The quantum measurement 130 may measure the qubits based on the system qubit SQB. In addition, the quantum measurement 130 may generate a probability distribution using values of the qubits based on the system qubit SQB to determine whether the verification target gate 200 is normally implemented.

The first verification circuit 110 may include a Pauli-X gate, a CNOT gate, a Hadamard gate, and a controlled Hadamard gate. The controlled Hadamard gate may be a gate in which the target portion of the CNOT gate is replaced with the Hadamard gate. That is, the controlled Hadamard gate may include the Hadamard gate and the control portion. Specifically, the controlled Hadamard gate may perform a matrix operation according to an [equation 1] below.

$$( \begin{matrix}1 & 0 & 0 & 0 \\ 0 & 1 & 0 & 0 \\ 0 & 0 & \frac{1}{\sqrt{2}} & \frac{1}{\sqrt{2}} \\ 0 & 0 & \frac{1}{\sqrt{2}} & - \frac{1}{\sqrt{2}}\end{matrix} ) \qquad [ equation 1 ]$$

In an embodiment, the first verification circuit 110 may include a plurality of CNOT gates. For example, the first verification circuit 110 may include three of CNOT gates operating based on the first qubit QB1 and the second qubit QB2, one of a CNOT gate operating based on the first qubit QB1 and the third qubit QB3, and one of a CNOT gate operating based on the second qubit QB2 and the fourth qubit QB4.

The first qubit QB1 input to the first verification circuit 110 may sequentially pass through the Hadamard gate, the control portion of the CNOT gate, the Hadamard gate included in the controlled Hadamard gate, two of controlled portions of two of CNOT gates, the Hadamard gate, and the control portion of the CNOT gate.

The second qubit QB2 input to the first verification circuit 110 may sequentially pass through the Pauli-X-gate, the target portion of the CNOT gate, the control portion included in the controlled Hadamard gate, the target portion of the CNOT gate, the control portion of the CNOT gate, and the target portion of the CNOT gate.

In an embodiment, the first verification circuit 110 may output according to the following [equation 2] including the first, second, and third vectors based on the first, second, third, and fourth qubits QB1, QB2, QB3, and QB4.

$${{{{{{\vert = \frac{1}{2} \vert {Φ}_{-} 〉}_{1 , 2} \vert {E}_{10} 〉}_{{1}^{′} , {2}^{′}} + \frac{1}{2} \vert {Ψ}_{+} 〉}_{1 , 2} \vert {E}_{01} 〉}_{{1}^{′} , {2}^{′}} + \sqrt{\frac{1}{2}} \vert {Ψ}_{-} 〉}_{1 , 2} \vert {E}_{11} 〉}_{{1}^{′} , {2}^{′}} \qquad [ equation 2 ]$$

where, | [symbol] [symbol] is the output of the first verification circuit, |E₁₀ [symbol] _{1′2′} is the first vector, |E₀₁ [symbol] _{1′,2′} is the second vector, |E₁₁ [symbol] _{1′2}′ is the third vector, 1, 2, 1′, and 2′ are the first qubit, the second qubit, the third qubit, and the fourth qubit respectively, and |ϕ₋ [symbol] _{1,2}, |Ψ₊ [symbol] _{1,2}, and |Ψ₋ [symbol] _{1,2} are defined by an [equation 3] below.

$${{{{{\vert {Φ}_{-} 〉}_{1 , 2} = \sqrt{\frac{1}{2}} ( \vert 0 〉}_{1} \vert 0 〉}_{2} - \vert 1 〉}_{1} \vert 1 〉}_{2} ) \qquad [ equation 3 ]$$

$${{{{{\vert {Ψ}_{+} 〉}_{1 , 2} = \sqrt{\frac{1}{2}} ( \vert 0 〉}_{1} \vert 0 〉}_{2} - \vert 1 〉}_{1} \vert 1 〉}_{2} )$$

$${{{{{\vert {Ψ}_{-} 〉}_{1 , 2} = \sqrt{\frac{1}{2}} ( \vert 0 〉}_{1} \vert 1 〉}_{2} - \vert 1 〉}_{1} \vert 0 〉}_{2} )$$

In an embodiment the first, second, and third vectors may orthogonal to each other. For example, the first vector may be |10>, the second vector may be |01>, and the third vector may be |11>. However, a combination of the first, second, and third vectors according to an embodiment of present inventive concept may not be limited to thereto.

However, a disposition of the gates included in the first verification circuit 110 according to the embodiments of the present inventive concept may not be limited thereto, and the disposition of the gates included in the first verification circuit 110 may have various dispositions, or one or more gates may be added or removed from the first verification circuit 110 depending on a number of input qubits, the type of input qubits, a combination of the basis states of the input qubits, and the like.

The second verification circuit 120 may include the Hadamard gate. The Hadamard gate may perform an operation based on the first qubit QB1. However, a disposition of the Hadamard gate included in the second verification circuit 120 according to the embodiments of the present inventive concept may not be limited thereto, and the Hadamard gate may be disposed to perform an operation based on one qubit among the second, third, and fourth qubits QB2, QB3, QB4.

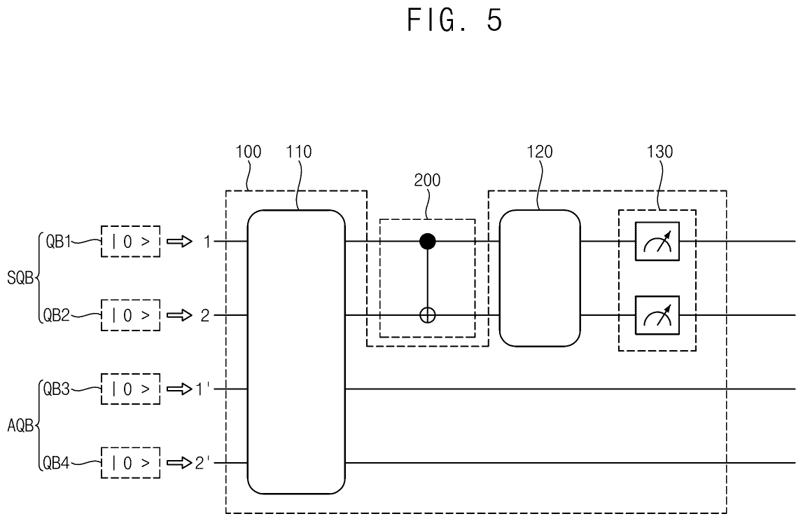

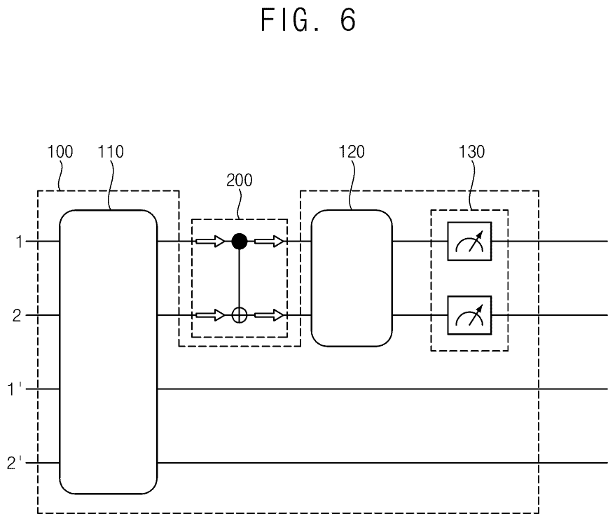

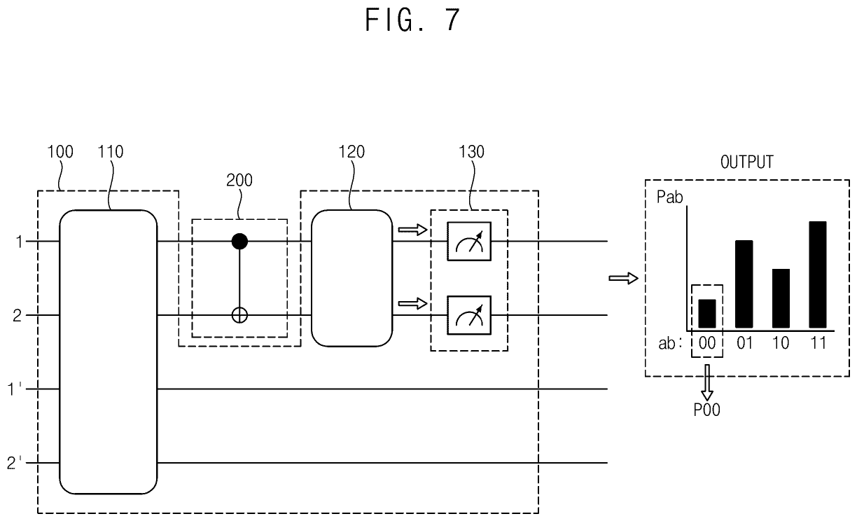

FIGS. 5, 6, and 7 are views illustrating a method for verifying a quantum gate using the quantum verification circuit of FIG. 2.

Referring to FIGS. 5, 6, and 7, the first, second, third, and fourth qubits QB1, QB2, QB3, and QB4 may be input to the quantum verification circuit 100. For example, each of the first, second, third, and fourth qubits QB1, QB2, QB3, and QB4 may be input as |0> to the first verification circuit 110. Specifically, the first second, third, and fourth qubits QB1, QB2, QB3, and QB4 may be input as |0>|0>|0>|0>. However, a combination of the first, second, third, and fourth qubits QB1, QB2, QB3, and QB4 input for performing a method for verifying a quantum gate may not be limited to thereto, each of the first, second, third, and fourth qubits QB1, QB2, QB3, and QB4 may be input to |0> or |1>, and inputs of the first, second, third, and fourth qubits QB1, QB2, QB3, and QB4 may have various combinations.

The first verification circuit 110 may generate qubits in a preliminary state for verification based on the first, second, third, and fourth qubits QB1, QB2, QB3, and QB4. The qubits in the preliminary state may be input to the verification target gate 200. The verification target gate 200 may generate an entangled state by operating the qubits in the preliminary state. For example, the verification target gate 200 may generate an entangled state by operating the qubits in the preliminary state based on the first qubit QB1 and the second qubit QB2.

An output of the verification target gate 200 may be output to the second verification circuit 120. Since the verification target gate 200 performs an operation based on the first qubit QB1 and the second qubit QB2, the second verification circuit 120 may also perform an operation based on the first qubit QB1 and the second qubit QB2. An output of the second verification circuit 120 may be input to the quantum measurement 130. Since the second verification circuit 120 performs an operation based on the first qubit QB1 and the second qubit QB2, the quantum measurement 130 may also measure the qubits based on the first qubit QB1 and the second qubit QB2 to determine whether the verification target gate 200 is normally implemented.

In an embodiment, the quantum measurement 130 may measure the entangled state generated by the verification target gate 200 to determine whether the verification target gate 200 is normally implemented. For example, since the verification target gate 200, which is a CNOT gate, is a gate that generates an entangled state, quantum measurement 130 may determine that the verification target gate 200 is normally implemented as a verification probability of the first, second, third, and fourth qubits QB1, QB2, QB3, and QB4 is lower. In addition, the quantum measurement 130 may determine that the verification target gate 200 is not normally implemented as the verification probability of the first, second, third, and fourth qubits QB1, QB2, QB3, and QB4 is greater.

Specifically, when each of the first, second, third, and fourth qubits QB1, QB2, QB3, and QB4 are input to the first verification circuit 110 as |0>, the quantum measurement 130 may generate a probability distribution of the values of the qubits output based on the first qubit QB1 and the second qubit QB2. The probability distribution may include probabilities that the values of the qubits have 00, 01, 10, and 11, respectively. For example, the probability distribution may include a probability that a probability P₀₀ when the values of the qubits are 00, a probability P₀₁ when the values of the qubits are 01, a probability Pio when the values of the qubits are 10, and a probability Pu when the values of the qubits are 11 are all zero. When the verification probability defined as the probability that the values of the qubits are all zero (e.g., the probability P₀₀ when the values of the qubits are 00) is less than about 0.125, the quantum measurement 130 may determine that a normal implementation of the verification target gate 200 is successful. In addition, when the verification probability is about 0.125 to about 0.375, the quantum measurement 130 may determine that the normal implementation of the verification target gate 200 fails. In addition, when the verification probability is greater than about 0.375, the quantum measurement 130 may determine that the normal implementation of the verification target gate 200 is successful. When the verification probability is greater than about 0.375, a certified target gate may have generated psi_(−) state.

Specifically, when |0>|0>|0>|0> is input as the first, second, third, and fourth qubits QB1, QB2, QB3, and QB4, the quantum measurement 130 may measure a first measurement probability P₀₀₀₀, which is the probability that |0>|0>|0>|0> is output, may measure a second measurement probability P₀₀₀₁, which is the probability that |0>|0>|0>|1> is output, may measure a third measurement probability P₀₀₁₀, which is the probability that |0>|0>|1>|0> is output, and may measure a fourth measurement probability Poon, which is the probability that |0>|0>|1>|1> is output. The quantum measurement 130 may operate an sum of the first, second, third, and fourth measurement probabilities. In an embodiment, the quantum measurement 130 may calculate sum of the first, second, third, and fourth measurement probabilities according to an [equation 4] below.

$${P}_{00} = {P}_{0000} + {P}_{0001} + {P}_{0010} + {P}_{0011} \qquad [ equation 4 ]$$

Where, P₀₀ is the verification probability, P_{abcd} is each of the measurement probabilities, and each of a, b, c, and d is a value output for the first qubit, the second qubit, the third qubit, and the fourth qubit.

In an embodiment, the quantum measurement 130 may determine that the verification target gate 200 is successfully implemented without error when the verification probability is zero. In addition, the quantum measurement 130 may determine that the verification target gate 200 is successfully implemented with a noise ratio equal to a value of the verification probability multiplied by a constant when the verification probability is greater than 0 and less than about 0.125. For example, the constant may be about 0.25. However, a value range of the verification probability and a value of the constant according to the embodiments of the present inventive concept may not be limited thereto.

As described above, in the quantum verification circuit 100 and the method for verifying the quantum gate using the quantum verification circuit 100, as the verification target gate 200 may be disposed between the first verification circuit 110 and the second verification circuit 120, and states of the qubits passing through the first verification circuit 110, the verification target gate 200, and the second verification circuit 120 may be measured to determine whether the verification target gate 200 is normally implemented, whether an implementation of an entangled state of the quantum gate, which is the verification target gate 200, fails or is successful may be easily determined. Accordingly, verification accuracy and efficiency of the quantum gate (e.g., the CNOT gate) implementing the entangled state may be improved. Accordingly, the quantum gate may be applied to a quantum circuit and a device, so a performance of the quantum circuit and the device using the quantum gate may be improved.

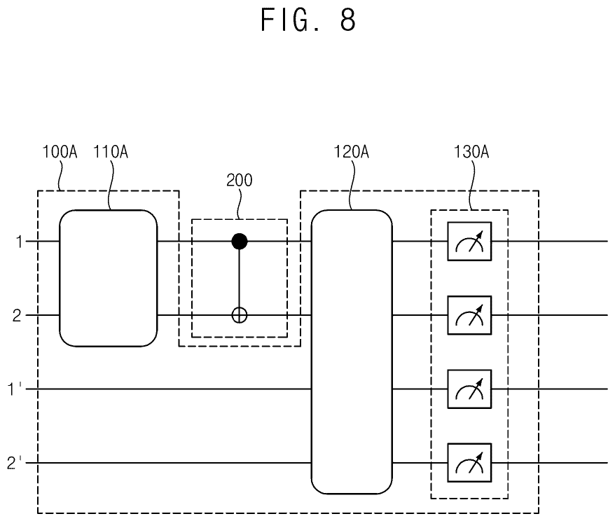

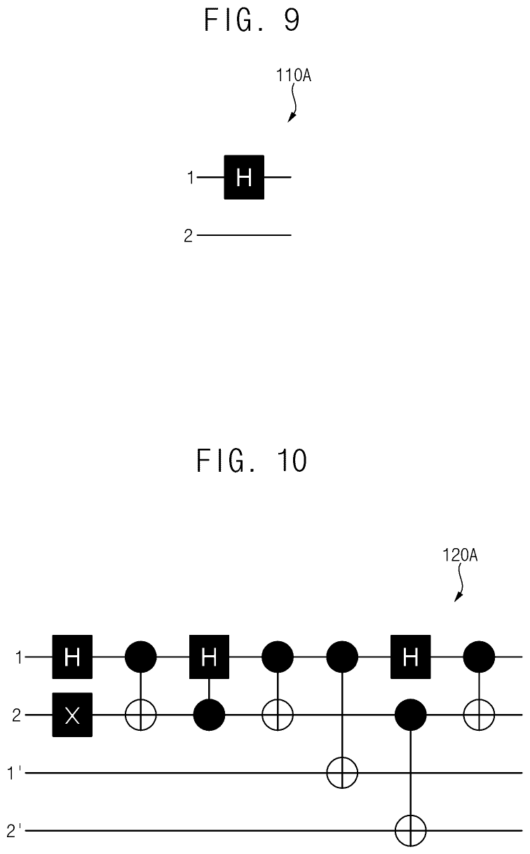

FIG. 8 is a view illustrating another example of the quantum verification circuit of FIG. 1. FIG. 9 is a view illustrating a first verification circuit of FIG. 8. FIG. 10 is a view illustrating a second verification circuit of FIG. 8.

A quantum verification circuit 100A described with reference to FIGS. 8, 9, and 10 may be substantially a same as or similar to the quantum verification circuit 100 described with reference to FIGS. 2, 3, and 4, except for a disposition relationship of a first verification circuit 110A and a second verification circuit 120A, and a measurement target of a quantum measurement 130A. Hereinafter, any content overlapping with the content described with reference to FIGS. 2, 3, and 4 will be omitted or simplified.

Referring to FIGS. 8, 9, and 10, a quantum verification circuit 100A may include a first verification circuit 110A, a second verification circuit 120A, and a quantum measurement 130A. The first verification circuit 110A may have a structure substantially a same as or similar to the second verification circuit 120 of FIG. 2. For example, the first verification circuit 110A may include the Hadamard gate. The second verification circuit 120A may have a structure substantially a same as or similar to the first verification circuit 110 of FIG. 2. For example, the second verification circuit 120A may include the Pauli-X-gate, the CNOT gate, the Hadamard gate, and the controlled Hadamard gate.

The system qubit SQB may be input to the first verification circuit 110A. For example, the first qubit QB1 and the second qubit QB2 may be input to the first verification circuit 110A. That is, the auxiliary qubit AQB may not be input to the first verification circuit 110A. Accordingly, the first verification circuit 110A may perform an operation based on the first qubit QB1 and the second qubit QB2. The first verification circuit 110A may not perform an operation based on the third qubit QB3 and the fourth qubit QB4. Accordingly, the first qubit QB1 and the second qubit QB2 may not create an overlap or entanglement relationship with the third qubit QB3 and the fourth qubit QB4 until the first qubit QB1 and the second qubit QB2 pass through the second verification circuit 120A.

Since the first verification circuit 110A performs an operation based on the first qubit QB1 and the second qubit QB2 and outputs to the verification target gate 200, the verification target gate 200 may perform an operation based on the first qubit QB1 and the second qubit QB2. The verification target gate 200 may generate an entangled state and output to the second verification circuit 120A.

An output of the verification target gate 200, the third qubit QB3, and the fourth qubit QB4 may be input to the second verification circuit 120A. The second verification circuit 120A may perform an operation based on the Pauli-X-gate, the CNOT gate, the Hadamard gate, and the controlled Hadamard gate and output to the quantum measurement 130A.

The quantum measurement 130A may measure qubits based on the system qubit SQB and the auxiliary qubit AQB. For example, the quantum measurement 130A may measure values of qubits output based on the first, second, third, and fourth qubits QB1, QB2, QB3, and QB4. Unlike the quantum measurement 130 of FIG. 2 that measures the values of two qubits, the quantum measurement 130A of FIG. 8 may measure values of four qubits. The quantum measurement 130A may generate a probability distribution using values of the qubits based on the system qubit SQB and the auxiliary qubit AQB to determine whether the verification target gate 200 is normally implemented.

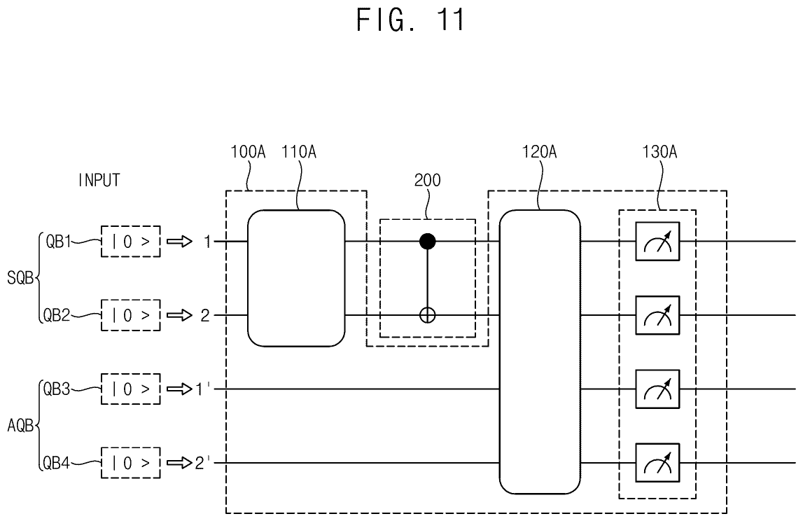

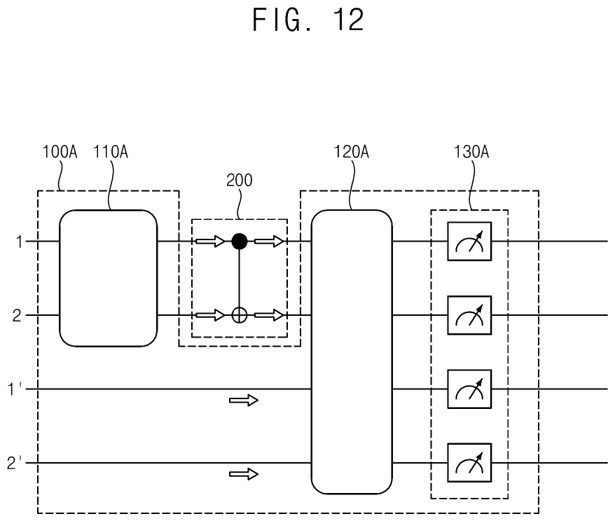

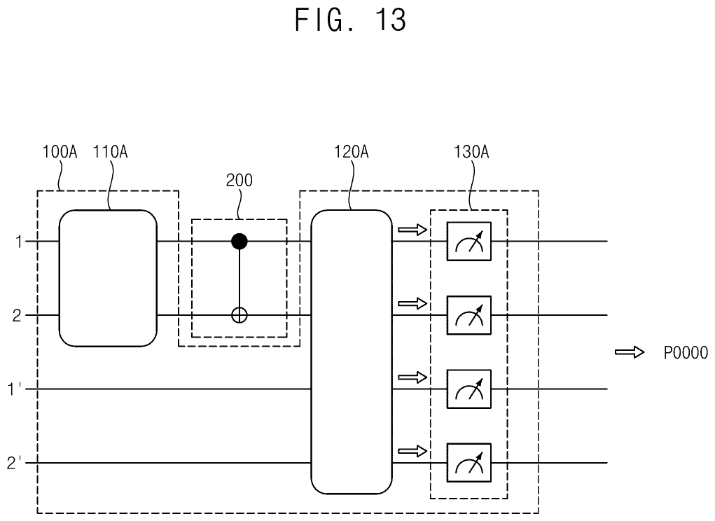

FIGS. 11, 12, and 13 are views illustrating a method for verifying a quantum gate using the quantum verification circuit of FIG. 8.

A method for verifying a quantum gate described with reference to FIGS. 11, 12, and 13 may be substantially a same as or similar to the method for verifying the quantum gate described with reference to FIGS. 5, 6, and 7, except using the quantum verification circuit 100A of FIG. 8. Hereinafter, any content overlapping with the content described with reference to FIGS. 5, 6, and 7 will be omitted or simplified.

Referring to FIGS. 11, 12, and 13, the first, second, third, and fourth qubits QB1, QB2, QB3, and QB4 may be input to the quantum verification circuit 100A. For example, each of the first qubit QB1 and the second qubit QB2 may be input to the first verification circuit 110A as |0>. Each of the third qubit QB3 and the fourth qubit QB4 may be input to the second verification circuit 120A as |0>. Specifically, the first, second, third, and fourth qubits QB1, QB2, QB3, and QB4 may be input as |0>|0>|0>|0>, |0>|0>|0>|1>, |0>|0>|1>|0>, and |0>|0>|1>|1>. However, a combination of the first, second, third, and fourth qubits QB1, QB2, QB3, and QB4 input to perform the method for verifying the quantum gate according to the embodiments of the present inventive concept may not be limited thereto, and each of the first, second, third, and fourth qubits QB1, QB2, QB3, and QB4 may be input as |0> or |1>, so that the input of the first, second, third, and fourth qubits QB1, QB2, QB3, and QB4 may have various combinations.

The first verification circuit 110A may generate qubits in a preliminary state for verification based on the first qubit QB1 and the second qubit QB2. The qubits in the preliminary state may be input to the verification target gate 200, and the verification target gate 200 may generate an entangled state by operating the qubits in the preliminary state. The output of the verification target gate 200, the third qubit QB3 and the fourth qubit QB4 may be input to the second verification circuit 120A, and the second verification circuit 120A may perform an operation based on the first, second, third, and fourth qubits QB1, QB2, QB3, and QB4. The second verification circuit 120A may perform an operation based on the first, second, third, and fourth qubits QB1, QB2, QB3, and QB4 and output the result to the quantum measurement 130A. Since the second verification circuit 120A performs an operation based on the first, second, third, and fourth qubits QB1, QB2, QB3, and QB4, the quantum measurement 130A may also measure the qubits based on the first, second, third, and fourth qubits QB1, QB2, QB3, and QB4 to determine whether the verification target gate 200 is normally implemented.

In an embodiment, the quantum measurement 130A may measure a verification probability defined as a probability that a value of each of the qubits output based on the first, second, third, and fourth qubits QB1, QB2, QB3 and QB4 has a specific value. For example, when the first, second, third, and fourth qubits QB1, QB2, QB3, and QB4 are input as |0>|0>|0>|0>, |0>|0>|0>|1>, |0>|0>|1>|0>, and |0>|0>|1>|1> the quantum measurement 130A may measure the verification probability, which is the probability that the values of each of the qubits output based on the first, second, third, and fourth qubits QB1, QB2, QB3 and QB4 are zero. Specifically, when the first, second, third, and fourth qubits QB1, QB2, QB3, and QB4 are input so that a number of times the first, second, third, and fourth qubits QB1, QB2, QB3, and QB4 are input as 0>|0>|0>|0>, a number of times the first, second, third, and fourth qubits QB1, QB2, QB3, and QB4 are input as 0>|0>|0>|1>, a number of times the first, second, third, and fourth qubits QB1, QB2, QB3, and QB4 are input as |0>|0>|1>|0>, and a number of times the first, second, third, and fourth qubits QB1, QB2, QB3, and QB4 are input as |0>|0>|1>|1> are equal to each other, the quantum measurement 130A may measure the verification probability, which is the probability that |0>|0>|0>|0> is output. In other words, the verification probability may be the probability that 0>|0>|0>|0> is output to the quantum measurement 130A when the number of times 0>|0>|0>|0> is input, the number of times 0>|0>|0>|1> is input, the number of times 0>|0>|1>|0> is input, and the number of times 0>|0>|1>|1> is input are equal to each other. The verification probability with reference to FIGS. 11, 12, and 13. may be corresponding to the first measurement probability P₀₀₀₀ as described with reference to FIGS. 5, 6, and 7.

The quantum measurement 130A is described as operating the verification probability, however the quantum measurement 130A according to the embodiments of the present inventive concept may not be limited thereto.

When the verification probability is less than about 0.125, the quantum measurement 130A may determine that a normal implementation of the verification target gate 200 is successful. In addition, when the verification probability is about 0.125 to about 0.375, the quantum measurement 130A may determine that the normal implementation of the verification target gate 200 fails. In addition, when the verification probability is greater than about 0.375, the quantum measurement 130A may determine that the normal implementation of the verification target gate 200 is successful. When the verification probability is greater than about 0.375, a certified target gate may have generated psi_(−) state.

In an embodiment, the quantum measurement 130A may determine that the verification target gate 200 is successfully implemented without error when the verification probability is zero. In addition, the quantum measurement 130A may determine that the verification target gate 200 is successfully implemented when the verification probability is greater than 0 and less than about 0.125, with a noise ratio equal to a value of the verification probability multiplied by a constant. For example, the constant may be about 0.25. However, a value range of the verification probability and a value of the constant according to embodiments of the present inventive concept may not be limited thereto.

As described above, in the quantum verification circuit 100A and the method for verifying the quantum gate using the quantum verification circuit 100A, as the verification target gate 200 may be disposed between the first verification circuit 110A and the second verification circuit 120A, and states of the qubits passing through the first verification circuit 110A, the verification target gate 200, and the second verification circuit 120A may be measured to determine whether the verification target gate 200 is normally implemented, whether an implementation of an entangled state of the quantum gate, which is the verification target gate 200, fails or is successful may be easily determined. Accordingly, verification accuracy and efficiency of the quantum gate (e.g., the CNOT gate) implementing the entangled state may be improved. Accordingly, the quantum gate may be applied to a quantum circuit and a device, so a performance of the quantum circuit and the device using the quantum gate may be improved.

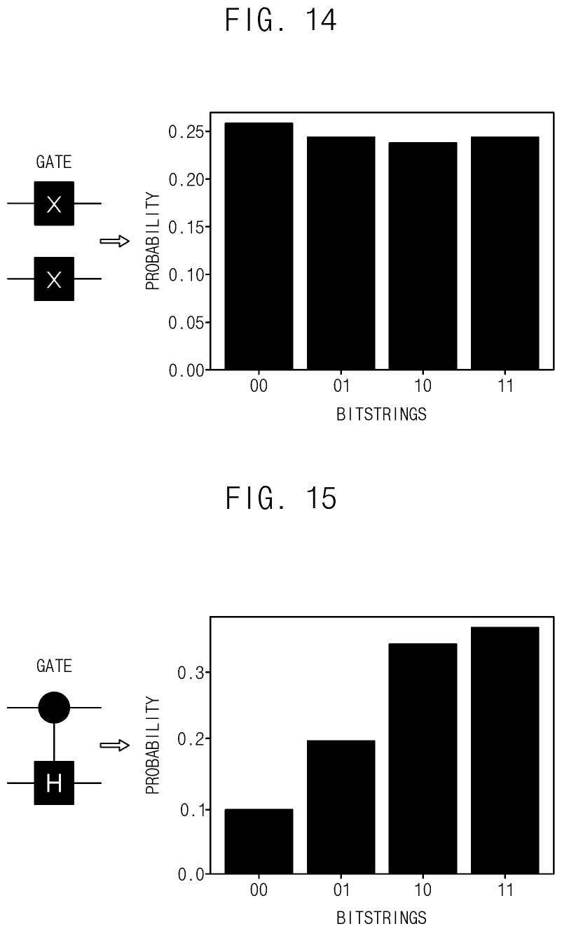

FIGS. 14, 15, and 16 are views explaining for an effect of the quantum verification circuit of FIG. 1.

Referring to FIGS. 14, 15, and 16, a value of a probability distribution measured using the quantum verification circuit 100 of FIG. 2 may be confirmed for the verification target gate according to a comparative example and an example.

A Comparative Example 1 according to FIG. 14 used an X-X gate connected between the first verification circuit 110 and the second verification circuit 120 of FIG. 2 as a verification target gate. Specifically, Comparative Example 1 used a X-X gate instead of a CNOT gate which is a combination of a Hadamard gate connected to the first qubit QB1 and used a Hadamard gate connected to the second qubit QB2.

A Comparative Example 2 according to FIG. 15 used a controlled Hadamard gate connected between the first verification circuit 110 and the second verification circuit 120 of FIG. 2 as a verification target gate. Specifically, Comparative Example 2 used a controlled Hadamard gate which includes a control portion connected to the first qubit QB1 and a Hadamard gate connected to the second qubit QB2, instead of a CNOT gate.

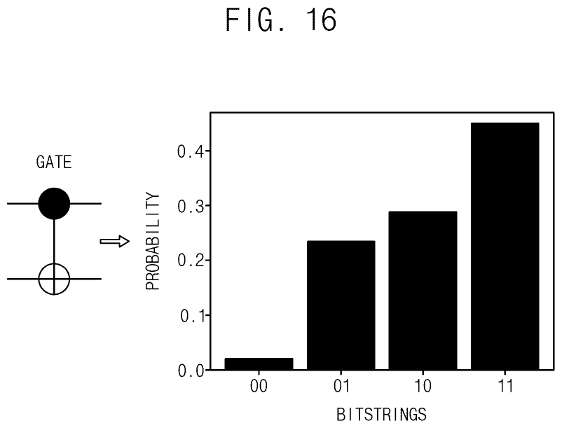

An Example according to FIG. 16 used a CNOT gate connected between the first verification circuit 110 and the second verification circuit 120 of FIG. 2 as a verification target gate. Specifically, the Example used a CNOT gate which includes a control portion connected to the first qubit QB1 and a target portion connected to the second qubit QB2.

The quantum verification circuit 100 of FIG. 2 was repeatedly operated for 2048 times using the quantum verification circuit 100 of the Example and Comparative Examples. Values of the verification probability P₀₀, a noise ratio, and success or failure of implementing an entangled state of the quantum gate according to the Example and the Comparative Examples are as illustrated in Table 1 below. Inputs of the first, second, third, and fourth qubits of each of the Example and the Comparative examples were |0>|0>|0>|0>.

TABLE 1

| | | noise | success |
|---|---|---|---|
| | P₀₀ | ratio(%) | of fail |
| Example | 0.2612 | — | fail |
| Comparative Example 1 | 0.0952 | 2.5 | success |
| Comparative Example 2 | 0.0195 | 0.5 | success |

The verification probability of Comparative Example 1 was measured to be the largest, and the verification probability of the Example was measured to be the smallest. In addition, since the verification probabilities measured in Comparative Example 2 and the Example, which include gates advantageous for generating an entangled state, had values less than 0.125, the implementation of the entangled state of the quantum gate in Comparative Example 2 and the Example was successful. In addition, since the verification probability measured in Comparative Example 1 had a value greater than 0.125, the implementation of the entangled state of the quantum gate in Comparative Example 1 failed. Accordingly, the quantum verification circuit 100 of FIG. 2 may easily and accurately verify a quantum entangled state through a quantum gate, and that the verification probability most suitable for the CNOT gate may be derived.

The quantum verification circuit 100 and 100A and the verification target gate 200 according to the embodiments of the present inventive concept may be used for verifying or operating quantum circuits included in various devices. The quantum verification circuit 100 and 100A may be included in the device or connected externally to the device. The device may correspond to various types of electronic devices such as a mobile user terminal (e.g., a smart phone, a laptop, a wearable device, and the like.) or a fixed management device (e.g., a server, a PC, and the like.). In addition, the device may be an exemplary hardware/software architecture such as a device for designing or implementing a quantum circuit.

In addition, the quantum verification circuit 100 and 100A and the verification target gate 200 according to the embodiments of the present inventive concept may be implemented by hardware, firmware, software, or a combination thereof. In the case of implementation by hardware, the quantum verification circuit 100 and 100A and the verification target gate 200 may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, and the like.

An operation according to the quantum gate verification method using the quantum verification circuit 100, and 100A of the present inventive concept may be implemented by software or machine-executable instructions (e.g., an operating system, an application, firmware, a program, etc.) that are executed on a device or a computer, and a non-transitory computer-readable medium in which such software or instructions are stored and executed on the device or the computer.

Although the circuits and the methods according to the embodiments have been described with reference to the drawings, the illustrated embodiments are examples, and may be modified and changed by a person having ordinary knowledge in the relevant technical field without departing from the technical spirit described in the following claims.

What is claimed is:

1. A quantum verification circuit comprising:
a first verification circuit configured to receive a plurality of qubits, configured to perform a first operation based on the plurality of qubits and configured to output a result of the first operation to a verification target gate;
a second verification circuit configured to receive the plurality of qubits in an entangled state from the verification target gate, and configured to perform a second operation based on the plurality of qubits in the entangled state; and
a quantum measurement configured to receive an output of the second verification circuit, and configured to determine whether the verification target gate is normally implemented by determining the entangled state of the plurality of qubits.

2. The quantum verification circuit of claim 1, wherein the verification target gate is CNOT gate.

3. The quantum verification circuit of claim 1, wherein the first verification circuit includes at least one selected from a group consisting of a Pauli-X-gate, a CNOT gate, and a Hadamard gate, and
wherein the second verification circuit includes the Hadamard gate.

4. The quantum verification circuit of claim 3, wherein the first verification circuit further includes a controlled Hadamard gate defined as a gate configured to perform a matrix operation according to an [equation 1] below.
$$( \begin{matrix}1 & 0 & 0 & 0 \\ 0 & 1 & 0 & 0 \\ 0 & 0 & \frac{1}{\sqrt{2}} & \frac{1}{\sqrt{2}} \\ 0 & 0 & \frac{1}{\sqrt{2}} & - \frac{1}{\sqrt{2}}\end{matrix} ) \qquad [ equation 1 ]$$

5. The quantum verification circuit of claim 1, wherein a first qubit, a second qubit, a third qubit, and a fourth qubit are input to the first verification circuit.

6. The quantum verification circuit of claim 5, wherein the first verification circuit generates an output according to an [equation 2] below including a first vector, a second vector, and a third vector based on the first qubit, the second qubit, the third qubit, and the fourth qubit.
$${{{{{{\vert = \frac{1}{2} \vert {Φ}_{-} 〉}_{1 , 2} \vert {E}_{10} 〉}_{{1}^{′} , {2}^{′}} + \frac{1}{2} \vert {Ψ}_{+} 〉}_{1 , 2} \vert {E}_{01} 〉}_{{1}^{′} , {2}^{′}} + \sqrt{\frac{1}{2}} \vert {Ψ}_{-} 〉}_{1 , 2} \vert {E}_{11} 〉}_{{1}^{′} , {2}^{′}} \qquad [ equation 2 ]$$
where, | [symbol] [symbol] is the output of the first verification circuit, |E₁₀ [symbol] _{1′,2′} is the first vector, |E₀₁ [symbol] _{1′,2′} is the second vector, |E₁₁ [symbol] _{1′,2′} is the third vector, 1, 2, 1′, and 2′ are the first qubit, the second qubit, the third qubit, and the fourth qubit respectively, and |ϕ₋ [symbol] _{1,2}, |Ψ₊ [symbol] _{1,2}, and |Ψ₋ [symbol] _{1,2} are defined by an [equation 3] below.
$${{{{{\vert {Φ}_{-} 〉}_{1 , 2} = \sqrt{\frac{1}{2}} ( \vert 0 〉}_{1} \vert 0 〉}_{2} - \vert 1 〉}_{1} \vert 1 〉}_{2} ) \qquad [ equation 3 ]$$
$${{{{{\vert {Ψ}_{+} 〉}_{1 , 2} = \sqrt{\frac{1}{2}} ( \vert 0 〉}_{1} \vert 0 〉}_{2} - \vert 1 〉}_{1} \vert 1 〉}_{2} )$$
$${{{{{\vert {Ψ}_{-} 〉}_{1 , 2} = \sqrt{\frac{1}{2}} ( \vert 0 〉}_{1} \vert 1 〉}_{2} - \vert 1 〉}_{1} \vert 0 〉}_{2} ) .$$

7. The quantum verification circuit of claim 6, wherein the first vector, the second vector, and the third vectors are orthogonal to each other.

8. The quantum verification circuit of claim 5, wherein when each of the first vector, the second vector, the third vector, and the fourth vector is input as |0>,
the quantum measurement determines whether the verification target gate is normally implemented by measuring a verification probability defined as a probability that values of qubits output from the second verification circuit based on the first qubit and the second qubit are all zero.

9. The quantum verification circuit of claim 8, wherein when a value of the verification probability is less than about 0.125, the quantum measurement determines that a normal implementation of the verification target gate is successful.

10. The quantum verification circuit of claim 8, wherein when a value of the verification probability is equal to or greater than about 0.125 and equal to or less than about 0.375, the quantum measurement determines that a normal implementation of the verification target gate fails.

11. The quantum verification circuit of claim 1, wherein the second verification circuit includes at least one selected from a group consisting of a Pauli-X-gate, a CNOT gate, and a Hadamard gate.

12. The quantum verification circuit of claim 11, wherein the first verification circuit includes the Hadamard gate, and
wherein the second verification circuit further includes a controlled Hadamard gate.

13. The quantum verification circuit of claim 1, wherein when each of a first qubits, a second qubits, a third qubits, and a fourth qubits is input as |0>,
the quantum measurement determines whether the verification target gate is normally implemented by measuring a sum of measurement probabilities defined as a verification probability that a value output from the second verification circuit for each of the first qubit and the second qubit has a specific value.

14. The quantum verification circuit of claim 13, wherein the specific value for each of the first qubit and the second qubit is zero, and
wherein the quantum measurement operates the sum of the measurement probabilities according to an [equation 4] below.
$${P}_{00} = {P}_{0000} + {P}_{0001} + {P}_{0010} + {P}_{0011} \qquad [ equation 4 ]$$
where, P₀₀ is the verification probability, P_{abcd} is each of the measurement probabilities, and each of a, b, c, and d is a value output to the quantum measurement for the first qubit, the second qubit, the third qubit, and the fourth qubit.

15. The quantum verification circuit of claim 14, wherein when a value of the verification probability is less than about 0.125, the quantum measurement determines that a normal implementation of the verification target gate is successful.

16. The quantum verification circuit of claim 1, wherein the quantum measurement determines whether the verification target gate is normally implemented by measuring a verification probability defined as a probability that all values output from the second verification circuit for each of the first qubit, the second qubit, the third qubit, and the fourth qubit are zero.

17. A method for verifying a quantum gate, the method comprising:
generating qubits in a preliminary state for verification based on at least two or more qubits;
generating an entangled state by inputting the qubits in the preliminary state to a verification target gate; and
determining whether the verification target gate is normally implemented by measuring the entangled state.

18. The method of claim 17, wherein in the generating the qubits in the preliminary state, the qubits in the preliminary state are generated based on a first qubit and a second qubit,
wherein each of the first qubit, the second qubit, a third qubit, and a fourth qubit is input as |0>, and
wherein in the determining whether the verification target gate is normally implemented, whether the targe verification gate is normally implemented is determined by measuring a sum of measurement probabilities defined as a probability that a value output from the second verification circuit for each of the first qubit and the second qubit has a specific value.

19. The method of claim 18, wherein in the determining whether the verification target gate is normally implemented, the specific value output based on the first qubit and the second qubit is zero,
wherein the verification probability is operated according to an [equation 5] below, and
wherein when the verification probability is less than about 0.125, a success of normal implementation of the verification target gate is determined.
$${P}_{00} = {P}_{0000} + {P}_{0001} + {P}_{0010} + {P}_{0011} \qquad [ equation 5 ]$$
where, P₀₀ is the verification probability, P_{abcd} is each of the measurement probabilities, and each of a, b, c, and d is a value output for the first qubit, the second qubit, the third qubit, and the fourth qubit.

20. The method of claim 17, wherein in the generating the qubits in the preliminary state, the qubits in the preliminary state are generated based on a first qubit, a second qubit, a third qubit, and a fourth qubit,
wherein in the determining whether the verification target gate is normally implemented, when a probability that values of qubits output based on the first qubit, the second qubit, the third qubit, and the fourth qubit are all zero is less than about 0.125, a success of normal implementation of the verification target gate is determined, and
wherein in the determining whether the verification target gate is normally implemented, when the probability that values of qubits output based on the first qubit, the second qubit, the third qubit, and the fourth qubit are all zero is equal to or greater than about 0.125 and equal to or less than about 0.375, a failure of the normal implementation of the verification target gate is determined.
